(19) United States
(12) Patent Application Publication
(10) Pub. No.: US 2024/0265276 A1
(43) Pub. Date: Aug. 8, 2024

(54) RECONCILIATION OF TIME SERIES FORECASTS

(71) Applicant: International Business Machines Corporation, Armonk, NY (US)

(72) Inventors: Syed Yousaf Shah, Yorktown Heights, NY (US); Subha Nawer Pushpita, Cambridge, MA (US); Xuan-Hong Dang, Chappaqua, NY (US); Petros Zerfos, New York, NY (US)

(21) Appl. No.: 18/329,651

(22) Filed: Jun. 6, 2023

(30) Foreign Application Priority Data
Jan. 30, 2023 (GR) 20230100069

(51) Int. Cl. G06N 5/022

(52) U.S. Cl. CPC G06N 5/022

(57) ABSTRACT

A method of generating forecasts from time series data includes receiving a set of time series data organized according to a data structure having a plurality of nodes, generating a plurality of base forecasts, including a base forecast for each node, and selecting a sub-set of the plurality of nodes as fixed nodes. The method also includes performing a reconciliation process to generate reconciled forecasts, where the reconciliation process includes reconciling only the base forecasts of non-fixed nodes, and merging the base forecasts of the fixed nodes and the reconciled forecasts of the non-fixed nodes to generate an overall forecast.

### BACKGROUND

Embodiments of the present invention relate to time series data, and more specifically, to time series data forecasting and reconciliation.

With the development of computer, data communication and real-time monitoring technologies, time series databases have been widely applied to many aspects such as device monitoring, production line management and financial analysis. A time sequence refers to a set of measured values that are arranged in temporal order, and a time series database refers to a database for storing these measured values. Examples of time series data include server metrics, performance monitoring data, network data, sensor data, events, clicks, trades in a market, and various types of analytics data.

### SUMMARY

Embodiments of the present invention are directed to a method of generating forecasts from time series data. The method includes receiving a set of time series data organized according to a data structure having a plurality of nodes, generating a plurality of base forecasts, including a base forecast for each node, and selecting a sub-set of the plurality of nodes as fixed nodes. The method also includes performing a reconciliation process to generate reconciled forecasts, where the reconciliation process includes reconciling only the base forecasts of non-fixed nodes, and merging the base forecasts of the fixed nodes and the reconciled forecasts of the non-fixed nodes to generate an overall forecast.

Other embodiments of the present invention implement features of the above-described method in apparatuses, computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 illustrates a computer system, which is applicable to implement the embodiments of the present invention;

FIG. 2 depicts an example of a data structure organized as a hierarchical time series;

FIG. 3 depicts an example of a data structure organized as a grouped time series;

FIG. 4 depicts a prediction module for generating forecasts from time series data, according to one or more embodiments of the present invention;

FIG. 5 is a block diagram depicting a method of generating and reconciling forecasts from time series data, according to one or more embodiments of the present invention;

FIG. 6 is a block diagram depicting a method of reconciling forecasts from time series data, according to one or more embodiments of the present invention;

FIG. 7 is a block diagram depicting a method of selecting nodes as fixed nodes as part of reconciling forecasts generated from time series data, according to one or more embodiments of the present invention; and

FIG. 8 depicts a computing environment according to one or more embodiments of the present invention.

### DETAILED DESCRIPTION

Systems, devices and methods are provided for managing a time series database and forecasting based on time series data. An embodiment of the present invention includes a method of generating forecasts from time series data organized according to a data structure. The data structure may be a hierarchical time series (HTS) structure, a grouped time series (GTS) structure, or a structure having both hierarchical and grouped relationships. The method includes generating individual forecasts, also referred as base forecasts, for each node in a time series data structure, and reconciling the forecasts to ensure that relationships between nodes are preserved.

The method includes, prior to reconciliation, selecting a subset of the nodes as “fixed” nodes. Forecasts on fixed nodes are not changed or reconciled (i.e., the time series values in a fixed node are held constant) during reconciliation. The method also includes a number of forecast reconciliation strategies, which can be selected based on whether computational stability or computational efficiency is prioritized.

Embodiments of the present invention described herein provide a number of advantages and technical effects. For example, one or more embodiments reduce the intensity and complexity of computations by excluding nodes considered to be more stable from reconciliation. In addition, mechanisms provided for forecast reconciliation can be compatible and complementary to some existing forecasting models, and can be employed on top of such models to further enhance these existing models.

Current approaches for reconciling forecasts have limitations, in that such approaches are computationally intensive and require a large number of assumptions. Embodiments of the present invention address such limitations by providing techniques and methods that require fewer assumptions and are more computationally efficient, while preserving relationships between forecasts.

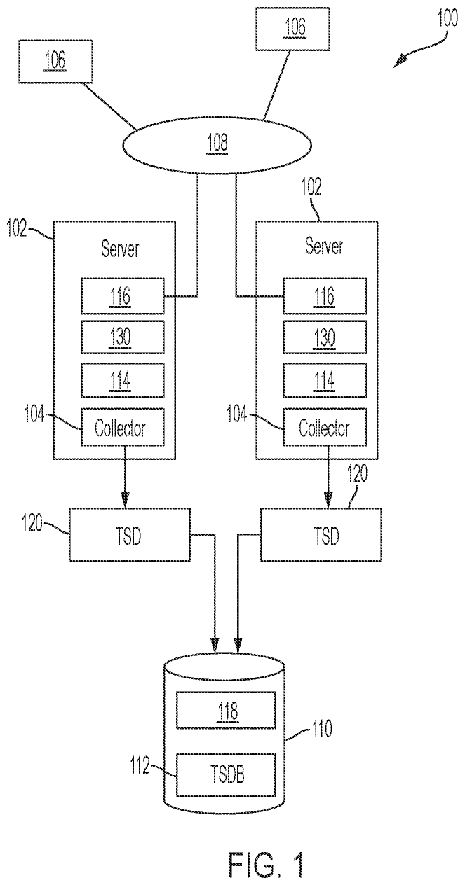

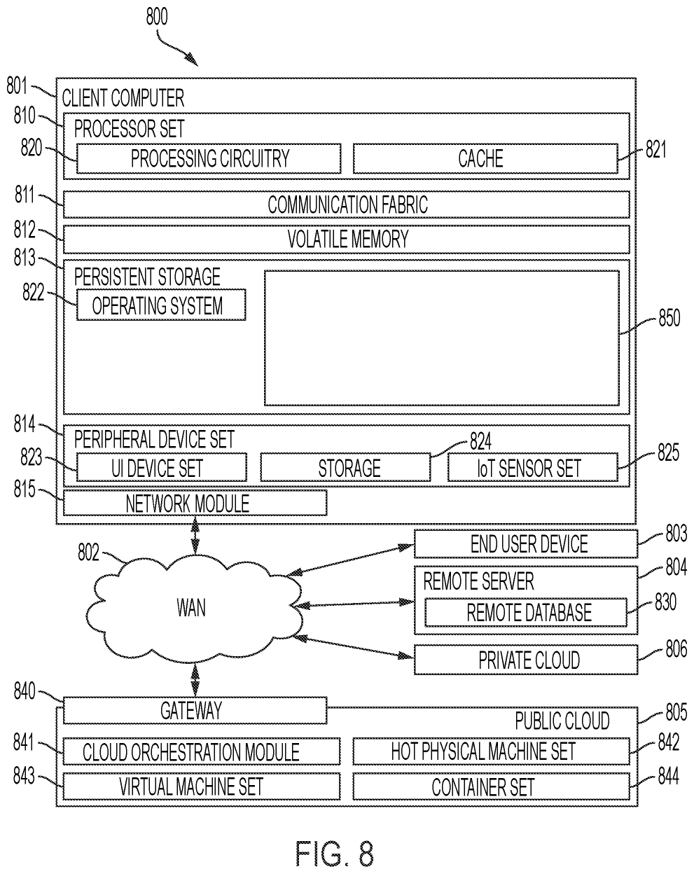

FIG. 1 depicts an example of components of a computing system 100 in accordance with one or more embodiments of the present invention. Generally, the system 100 includes one or more servers 102 (or other processing devices or systems), each having a collection module 104 for receiving data from various sources, such as client devices (clients) 106. The client devices 106 are communicatively connected to the servers 102 via a network 108, such as a cloud network or cloud computing environment (e.g., the computing environment 800 of FIG. 8).

Each collection module 104 is configured to acquire data, such as metrics and other time series data from a client 106, as well as requests for predictions. Each collection module 104 can also be configured for storing time series data to (and retrieving time series data from) a time series data repository 110 that stores a time series database (TSDB) 112. Time series data includes, for example, pairs of timestamps and data values. Each repository 110 stores one or more processing modules for managing the TSDB 112, such as a database control processing module 118.

Each server 102 includes various processing modules, such as a TSDB management module 114 (e.g., HBase™) for storing to and retrieving from the TSDB 112, and a network communication module 116 (e.g., a HTTP server).

In an embodiment of the present invention, each server 102 transmits time series data to a time series daemon (TSD) 120, which is a software system that is optimized for storing and providing time series data. The TSD 120 can be stored at each server 102, at the repository or at any other suitable location. Each TSD 120 is configured to inspect received data, extract time series data therefrom, and send the time series data to the TSDB 18 for storage. Communication between the servers 102 and the TSDs 120 can be accomplished using a remote procedure call (RPC) protocol or other suitable protocol.

According to an embodiment of the present invention, the system 100 includes a processing device or system for generating predictions or forecasts from time series data. For example, each server 102 includes a prediction module 130 that receives time series data, and performs various functions related to prediction, such as forecasting, reconciliation and/or machine learning (ML).

In an embodiment of the present invention, the time series data is multivariant data that is organized according to a data structure that links various sub-sets (e.g., groups or nodes) of the time series data that have common characteristics. For example, the time series data is organized as hierarchical time series and/or a grouped time series. Hierarchical time series (HTS) are time series which have a clearly defined hierarchical structure featuring layers of nodes. In a given layer (excluding the uppermost layer), each node (child node) is uniquely nested within a node in a higher layer (parent node).

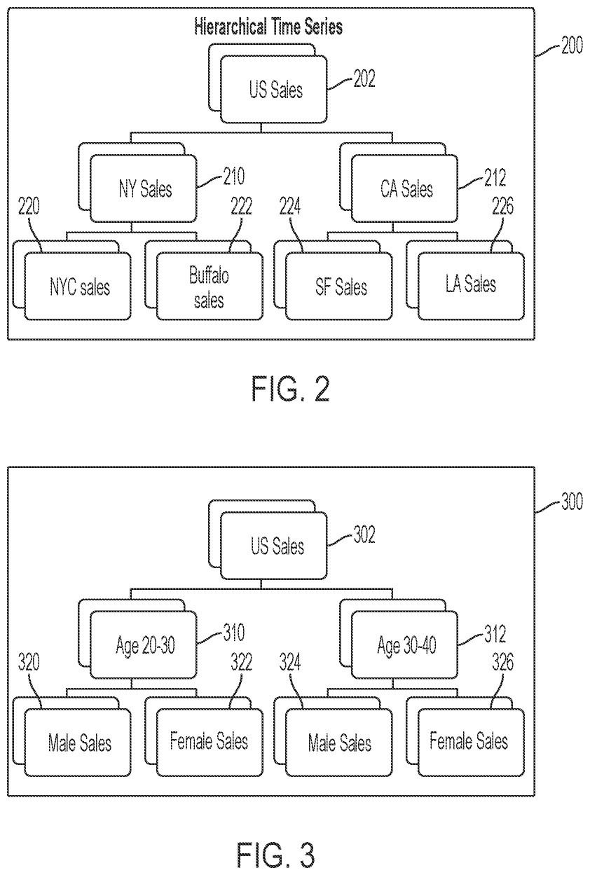

FIG. 2 shows an example of time series data organized as an HTS 200. In this example, the time series data is related to sales of a product in the United States. The HTS 200 has a highest layer (first layer) node 202 that encompasses all of the time series data, and has a lower layer (second layer) that groups or categorizes the time series data according to geographical region. One group is represented by a node 210 that includes sales data for New York state, and another group is represented by a node 212 that includes sales data for California. The nodes 210 and 212 are child nodes relative to the node 202, and the node 202 is a parent node relative to the nodes 210 and 212. A third layer further groups the time series data into categories (i.e., regions within states) that are unique to one of the categories of the second layer. The nodes 220 and 222 include data related to New York city sales and Buffalo city sales, respectively, and are uniquely related to the New York sales node 210 as child nodes. The node 224 includes data related to San Francisco sales, and the node 226 includes data related to Los Angeles sales. The nodes 224 and 226 are uniquely related to the California sales node 212 as child nodes. As is evident, each child node in a given layer is unique to the related parent node in the next higher layer.

Grouped Time Series (GTS) are time series that are grouped based on characteristics that are not unique to one higher layer group. It is noted that a given time series can have an organization that includes both hierarchical time series and grouped time series.

FIG. 3 shows the sales data of FIG. 3 organized as a GTS 300. In this organization, nodes in a layer are not necessarily unique to one parent node in a higher layer. The GTS 300 has a first layer including a node 302 that encompasses all of the sales data, and a second layer having nodes 310 and 312 that group the data according to customer age. The node 310 includes sales data for ages 20-30, and the node 312 includes sales data for ages 30-40. A third layer organizes customers as male and female. The third layer includes a male sales node 320 and a female sales node 322 related to the node 310, and also includes a male sales node 324 and a female sales node 326 related to the node 312. The GTS 300 does not have a strict hierarchical structure, as the categories of male sales and female sales are not unique to any one age category. In addition, the categories can be organized in various ways to produce different grouped time series. For example, the GTS 300 could be reorganized with male and female categories in the second layer, and age categories in the third layer.

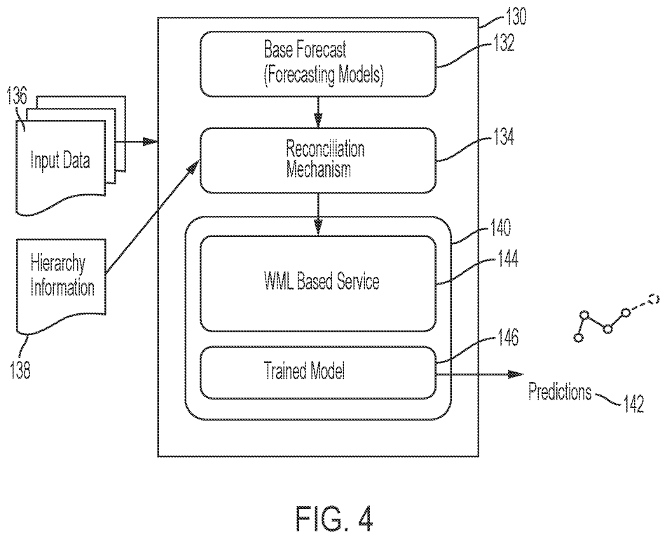

FIG. 4 depicts the prediction module 130 according to an embodiment of the present invention. The prediction module 130 includes a base forecasting module 132 that can generate initial forecasts from time series data (also referred to as “base forecasts”) using various forecasting models (e.g., autoregressive models, moving average models, ML models, etc.). A reconciliation module 134 receives input data 136 in the form of the time series data (e.g., hierarchical and/or grouped time series) and the base forecasts generated by the base forecasting module 132.

The reconciliation module 134 also receives hierarchy or grouping information 138 that specifies relationships between various nodes of the time series data. The reconciliation module 134 reconciles the base forecasts according to a selected reconciliation process or mechanism, and outputs the base forecasts. The base forecasts can then be used for prediction.

Reconciliation is performed to ensure that the base forecasts are coherent, so that the base forecasts and predictions therefrom maintain the relationships between nodes in a hierarchy. For example, forecasts generated from child nodes in a layer are coherent when the sum of the forecasts generated from the child nodes is equal to a forecast generated from a related parent node.

In an embodiment of the present invention, the reconciled base forecasts are received at a prediction module 140 configured to output predictions 142. The prediction module 140 can be configured to predict based on artificial intelligence and/or machine learning. For example, the prediction module 140 includes a training module 144 used to train a ML model 146, such as a neural network based model. ML models can be trained using various learning methods, such as deep learning, reinforcement learning and others.

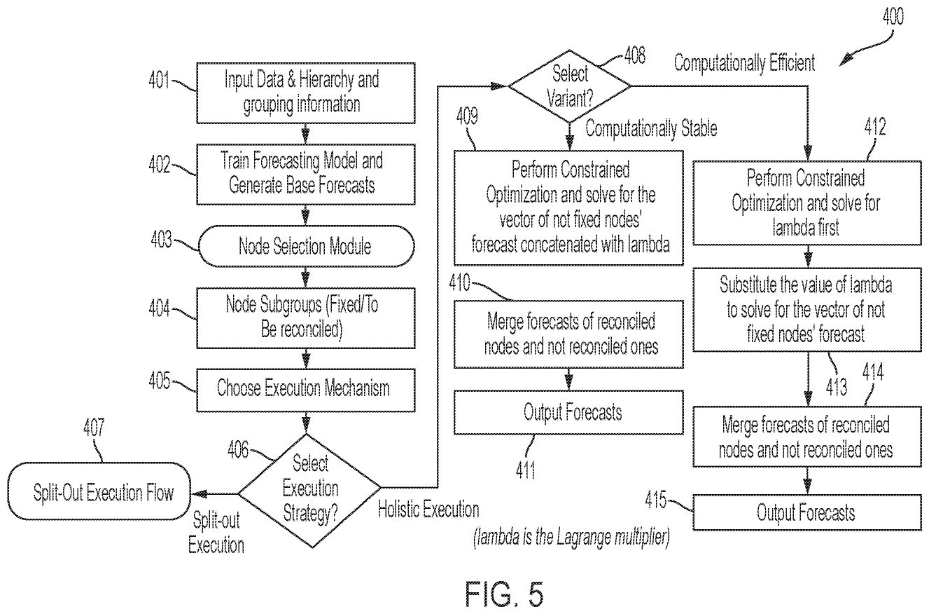

FIG. 5 illustrates aspects of an embodiment of a computer-implemented method 400 of generating forecasts from time series data organized as a grouped and/or hierarchical time series. The method 400 can be performed by a processor or processors, such as processing components of the server 12, but is not so limited. The method 400 is described as being performed by the prediction module 130 for illustration purposes; however, aspects of the method 400 can be performed by any suitable processing device or system.

The method 400 includes a plurality of stages or steps represented by blocks 401-415, all of which can be performed sequentially. However, in some embodiments, one or more of the stages can be performed in a different order than that shown or fewer than the stages shown can be performed.

At block 401, grouped and/or hierarchical time series data is input to the prediction module 130. The time series data is organized according to a hierarchical and/or grouped time series structure. In addition, hierarchy and grouping information is received.

At block 402, the base forecasting module 132 generates a forecast for each node in the time series data (referred to as a “base forecast”). Any time series forecasting mechanism can be used. For example, base forecasts can be generated using statistical models and/or ML-based models.

At block 403, a node selection process is performed, which includes selecting one or more nodes that are not to be reconciled during a subsequent reconciliation process (i.e., the values of each selected node are not changed during the subsequent reconciliation process). The selected nodes are referred to as “fixed” nodes. Nodes can be selected as fixed nodes by the reconciliation module 134, or selected by a separate node selection module.

Nodes can be selected according to any desired strategy. Generally, selection is based on the recognition that sub-sets of the time series data in different nodes may have different levels of stability or noisiness. Forecasts generated from more stable data sets are expected to be more stable, and can be excluded from the reconciliation process. As a result, the reconciliation process can be quicker and more efficient, as the number of computation is reduced.

In one strategy, nodes are randomly selected from each layer of the time series structure, under certain conditions. For example, bottom layer nodes are excluded from node selection. For any subtree in a hierarchy, the root node of the subtree is excluded from the node selection, and at least one of the bottom layer nodes of the subtree are excluded.

In another strategy, nodes are selected based on statistical characteristics. Only nodes having time series that are statistically stable (e.g., have a variability below a threshold, can be fit to a linear function, etc.) are selected, so that there is a reduced chance of noise on their forecasts. Nodes are selected via this strategy while enforcing the conditions discussed above.

In a further strategy, domain knowledge is used to inform which nodes are selected. Domain knowledge refers to pre-existing knowledge of the stability of various types of categories. For example, a user may have experience in a field related to the time series data, and select nodes that are expected to be more stable based on the user's experience. In this strategy, nodes are selected while enforcing the conditions discussed above.

At block 404, each node selected at block 403 is determined to be a fixed node. The remaining nodes (i.e., the nodes that were not selected during the node selection process) are referred to as “non-fixed” nodes.

At block 405, the prediction module selects an execution mechanism that will be used to reconcile forecasts associated with each node. Reconciliation is a process by which one or more forecasts are modified in order to ensure that the forecasts are coherent among all nodes, i.e., the hierarchical and/or grouping relationships are preserved. During the reconciliation process described further herein, fixed nodes are not changed; however, the fixed nodes can be utilized during reconciliation to confirm coherency among all of the nodes.

The execution mechanism generally provides for reconciling the forecasts from the non-fixed nodes. An example of a mechanism is a Lagrange multiplier based process such as empirical risk minimizer (ERM) reconciliation. Reconciliation mechanisms can utilize statistical forecasting and/or machine learning.

In an embodiment of the present invention, the execution mechanisms each involve solving a constrained optimization problem for the non-fixed node forecasts. The optimization problem includes at least one coherency constraint that enforces the hierarchical and/or grouped relationships between the various forecasts, and prevents the fixed nodes from being reconciled. In an embodiment of the present invention, a coherency constraint can be added to an existing mechanism as long as the mechanism retains its convex optimization problem, and the constrained optimization problem can be solved to find a closed form solution or formula.

At block 406, an execution strategy is selected. One execution strategy is a “holistic” strategy in which the reconciliation is performed on the entire data structure as one entity. Another execution strategy is a “split-out” strategy, in which the data structure is split into parts, and reconciliation is performed separately for each part.

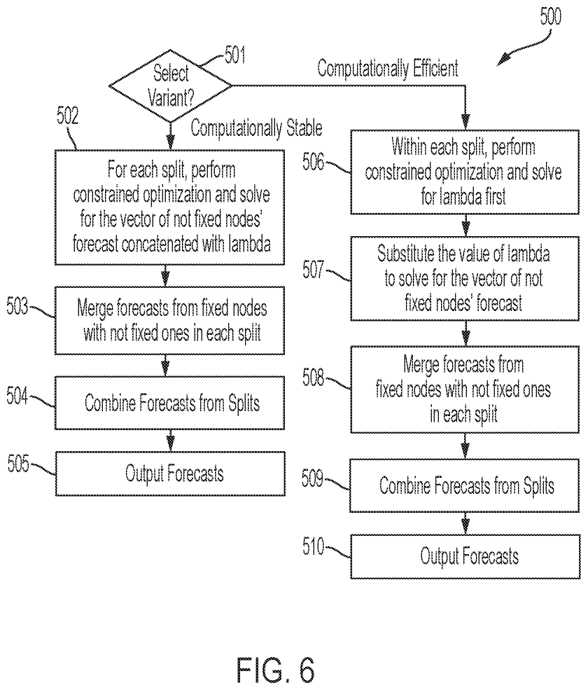

If the split-out strategy is selected, the method 406 proceeds to a split-out reconciliation process at block 407. The split-out reconciliation process is described further with reference to FIG. 6.

At block 408, if the holistic strategy is selected, the reconciliation module 134 selects one of at least two formulations of the selected reconciliation process. In an embodiment of the present invention, the formulations include a “computationally efficient” variant and a “computationally stable” variant.

The computationally efficient variant involves inverting a relatively small symmetric positive definite matrix, and therefore requires relatively few calculations. This variant is a two-step process. The computationally stable variant involves inverting a relatively large symmetric matrix but is a one-step process. Because this variant is a one-step process, it is more stable than the computationally efficient variant, which includes two steps. The computationally stable variant can be less prone to floating point errors.

Both variants utilize a Lagrange function L(y), where y represents forecasts associated with nodes in a given structure is a. The Lagrange function is represented by:

$$L ( y ) = {( {y}^{′} - t )}^{2} + λ ( {A}^{′} - {c}^{′} ) , \qquad ( 1 )$$

where λ is the Lagrange multiplier, y′ represents the reconciled forecasts of the non-fixed nodes (i.e., nodes selected to be reconciled), and [symbol] represents the base forecasts of the non-fixed nodes. The Lagrange function is solved for y′ by minimizing the Euclidean distance between the base forecasts and the reconciled forecasts, or (y′− [symbol] ).

A′ is a matrix that captures information describing the hierarchy of the time series structure (hierarchical relationships between nodes). c′ is a vector that has a value for each node in the data structure. c′ᵢ is a value for a given node with index i. c′ᵢ is equal to the base forecast of the given node if the given node is a fixed node. If the given node is non-fixed, then c′ᵢ is equal to zero.

At block 409, if the computationally stable variant has been selected, constrained optimization is performed, and the Lagrange function is solved for the vector y′ of non-fixed node forecasts concatenated with λ.

In the computationally stable variant, because the divergence of L equals zero, or partial derivatives of L with respect to y′ and λ are equal to zero, the following equations can be derived:

$$( \begin{matrix}2 I \\ {A}^{′}\end{matrix} \vert \begin{matrix}{A}^{rT} \\ 0\end{matrix} ) ( \begin{matrix}{y}^{′} \\ {λ}_{1}^{T}\end{matrix} ) = ( \begin{matrix}2 {{y}^{′}}_{t} \\ {c}^{′}\end{matrix} ) ; and \qquad ( 2 )$$

$${A}^{′} {y}^{′} = {c}^{′} . \qquad ( 3 )$$

The above equations can be rearranged to derive the following equation:

$$( \begin{matrix}2 I \\ {A}^{′}\end{matrix} \vert \begin{matrix}{A}^{rT} \\ 0\end{matrix} ) ( \begin{matrix}{y}^{′} \\ {λ}_{1}^{T}\end{matrix} ) = ( \begin{matrix}2 {{y}^{′}}_{t} \\ {c}^{′}\end{matrix} ) , \qquad ( 4 )$$

which is solved to find y′, or the reconciled forecasts of the non-fixed nodes.

At block 410, the reconciled forecasts of the non-fixed nodes (y′) are combined or merged with the base forecasts of the fixed nodes.

At block 411, the results are reported as a final forecast, which includes forecasts for each node (or a selected number of nodes). If a root node time series (i.e., a times series at the top of a subtree) is very noisy, then forecasts on the root node can optionally be reported as a sum of reconciled forecasts of immediate child nodes rather than originally reconciled forecasts.

At block 412, if the computationally efficient formulation has been selected, constrained optimization is performed first, and the Lagrange function is solved for 2 first, and then solved for y′. In the computationally stable formulation, equations (2) and (3) are derived. Solving for λ yields:

$$λ = {( {A}^{′} {A}^{′ T} )}^{- 1} ( 2 {A}^{′} - 2 {c}^{′} ) . \qquad ( 5 )$$

At block 413, the value of 2 is substituted in equation (5) to yields

$${y}^{′} = - {{A}^{′ T} ( {A}^{′} {A}^{′ T} )}^{- 1} ( {A}^{′} - {c}^{′} ) .$$

Equation (5) is then solved to determine the non-fixed reconciled forecasts (y′).

At block 414 the reconciled forecasts y′ of the non-fixed nodes are combined or merged with the forecasts of the fixed nodes.

At block 415, the results are reported as a final forecast, which includes forecasts for each node (or a selected number of nodes). If a root node time series (i.e., a times series that has child nodes) is very noisy, then forecasts on the root node can optionally be reported as a sum of reconciled forecasts of immediate child nodes rather than originally reconciled forecasts.

FIG. 6 illustrates an example of the split-out reconciliation process discussed at block 407 of FIG. 5. The split-out reconciliation process is described as a method 500, which can be performed by any suitable processor or processors, such as the prediction module.

The method 500 includes a plurality of stages or steps represented by blocks 501-510, all of which can be performed sequentially. However, in some embodiments, one or more of the stages can be performed in a different order than that shown or fewer than the stages shown can be performed.

AT block 501, the data structure is split into parts. If the data structure is a hierarchical (or a portion is hierarchical), the hierarchical structure or portion can be split horizontally or vertically. A horizontal split entails performing reconciliation according to layers (i.e., perform reconciliation on a bottom layer, then perform reconciliation successively for each higher layer). A vertical split entails splitting vertically using some form of domain knowledge to split into sections according to a domain (e.g., geographical region, time period, season, type of commerce, etc.), and then performing reconciliation for each section. During reconciliation, the coherency constraint can be formulated by providing different mathematical constraints across different splits, and enforcing the constraints in the optimization problem.

Also at block 501, a variant of a Lagrange-based reconciliation process is selected. For example, the predication module 134 selects either the computationally efficient variant or the computationally stable variant.

At block 502, if the computationally stable variant is selected, constrained optimization is performed for each split. For a given split, the Lagrange function is solved for the vector y′ of non-fixed node forecasts concatenated with λ, as discussed above.

At block 503, the base forecasts of the fixed nodes are merged with the reconciled forecasts of the non-fixed nodes for each split. At block 504, the merged forecasts of each split are combined, and the combined forecasts are output (block 505).

At block 506, if the computationally efficient process is selected, constrained optimization is performed for each split. For a given split, the Lagrange function is solved for λ first. At block 507, the value of λ is substituted in equation (5), and the function is solved for y′.

At block 508, the base forecasts of the fixed nodes are merged with the reconciled forecasts of the non-fixed nodes for each split. At block 509, the merged forecasts of each split are combined, and the combined forecasts are output (block 510).

In some instances, the data structure can include both hierarchical nodes, as well as grouped nodes that are not unique to a parent and can be rearranged. In such instances, the reconciliation process is modified to ensure solvability.

In the following, the modified process is discussed in relation to a data structure in which nodes in a given layer (e.g., bottom layer) can be grouped in two ways. An example of such a structure is shown in FIG. 3. As shown in FIG. 3, the bottom layer has nodes (male sales and female sales) that are grouped in two ways (age 20-30 and age 30-40), resulting in two hierarchies. It is noted that the modified process can be applied to any number of groupings, at any layer.

In the modified process, a number of nodes are selected as fixed nodes in each of the first hierarchy and the second hierarchy. y₁′ represents an array of reconciled forecasts of non-fixed nodes in all of the layers of the first hierarchy, and y₂′ represents an array of reconciled forecasts of non-fixed nodes in all of the layers of the second hierarchy.

The layers of the first hierarchy are aggregated, and an array u₁′ of reconciled forecasts of the aggregated layers is acquired. Similarly, the layers of the second hierarchy are aggregated, resulting in an array u₂′ of reconciled forecasts.

b′ denotes an array of reconciled forecasts of the bottom layer of each hierarchy. Therefore, y′, and y′₂ can be represented as

$${y}_{1}^{′} = [ {u}_{1}^{′} \vert {b}^{′} ] ; and \\ {y}_{2}^{′} = [ {u}_{2}^{′} \vert {b}^{′} ] .$$

y′ is then defined as:

$${y}^{′} = [ {u}_{1}^{′} \vert {u}_{2}^{′} \vert {b}^{′} ] .$$

Using this definition of y′, the Lagrange function is solved by minimizing (y′− [symbol] ) under the constraint A′y′=c′. In this case, A′ includes the hierarchy and node information of two different hierarchies.

A formulation is selected as discussed above, and the function is solved for optimal values of y′, which are output as reconciled forecasts.

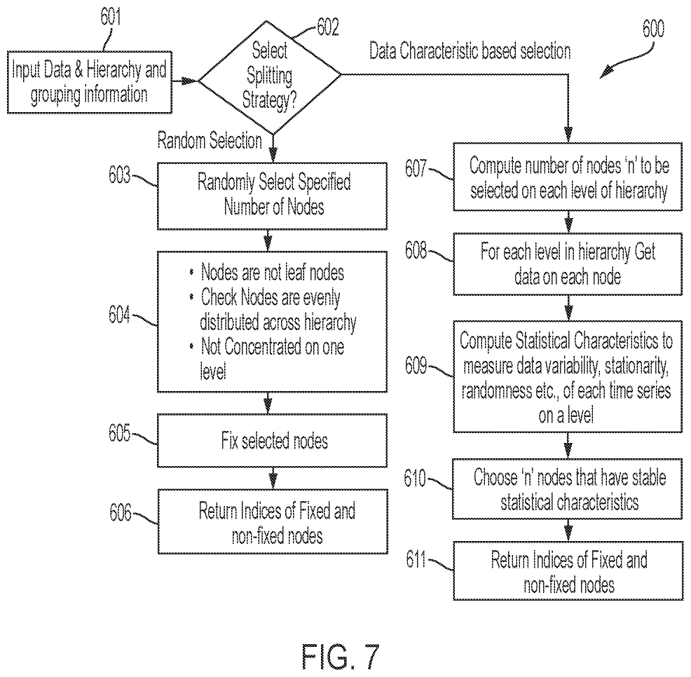

FIG. 7 illustrates an example of a node selection process, which can be performed at block 403 of FIG. 5. The node selection process is described as a method 600, which can be performed by any suitable processor or processors, such as the prediction module.

The method 600 includes a plurality of stages or steps represented by blocks 601-611, all of which can be performed sequentially. However, in some embodiments, one or more of the stages can be performed in a different order than that shown or fewer than the stages shown can be performed.

At block 601, grouped and/or hierarchical time series data is input to the prediction module 130, along with hierarchy and grouping information. At block 602, a node splitting strategy is selected. One strategy includes randomly selecting nodes subject to some restrictions (“random strategy”), and another strategy is based on statistical attributes of each node (“statistical strategy”).

At block 603, if the random strategy is selected, a desired number of nodes are randomly selected subject to certain conditions. For example, a node cannot be selected if the node is a leaf node (i.e., if the node does not have any child nodes). As the lowest level of a hierarchy has only leaf nodes, nodes from the lowest level cannot be selected.

At block 604, the reconciliation module 134 checks the selected nodes to confirm that none of the selected nodes are leaf nodes, and removes any leaf nodes from the selected nodes. In addition, the reconciliation module 134 checks whether the selected nodes are evenly distributed across the hierarchy. The nodes are considered evenly distributed, for example, if the same number of nodes or a similar number of nodes (e.g., within a selected difference) occur in each level of the hierarchy, or in each child group of a given node. This check is provided to avoid concentrating the fixed nodes on one level or a few levels. If the selected nodes are not evenly distributed, the reconciliation module 134 can re-select nodes or remove nodes accordingly.

At block 605, the selected nodes are identified as fixed nodes. At block 606, the index numbers (or other identifiers) of the fixed nodes are returned.

At block 607, if the statistical strategy is selected, the prediction module computes a number of nodes to be selected for each layer of the hierarchy, and the time series data for each node is acquired (block 608).

At block 609, statistical characteristics of each time series in a layer are computed. In an embodiment of the present invention, the statistical characteristics are related to statistical stability. Examples of such characteristics include data variability, stationarity, randomness and others.

At block 610, for a given hierarchy, a number of the nodes therein are selected that have the most stable statistical characteristic (e.g., lowest randomness). It is noted that blocks 609 and 610 can be repeated for each layer.

At block 611, the selected nodes are identified as fixed nodes, and the index numbers (or other identifiers) of the fixed nodes are returned.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 8 depicts an example computing environment 800 that can be used to implement aspects of the invention. Computing environment 800 contains an example of an environment for the execution of at least some of the computer code involved in performing the inventive methods, such as new personalized and context-aware explanation format generation code 850. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method of generating forecasts from time series data, the method comprising:
receiving a set of time series data organized according to a data structure having a plurality of nodes;
generating a plurality of base forecasts, including a base forecast for each node;
selecting a sub-set of the plurality of nodes as fixed nodes;
performing a reconciliation process to generate reconciled forecasts, wherein the reconciliation process includes reconciling only the base forecasts of non-fixed nodes;
merging the base forecasts of the fixed nodes and the reconciled forecasts of the non-fixed nodes to generate an overall forecast.

2. The method of claim 1, wherein the time series data is organized as at least one of a hierarchical time series and a grouped time series.

3. The method of claim 1, wherein selecting the sub-set includes at least one of:
randomly selecting nodes from the nodes of the data structure, excluding bottom layer nodes and leaf nodes;
selecting nodes based on knowledge relating to stability of a domain of each node; and
selecting nodes based on a statistical analysis of time series data in each node.

4. The method of claim 3, wherein selecting nodes based on the statistical analysis includes selecting the nodes based on a statistical stability of each node.

5. The method of claim 1, wherein the reconciliation process is based on a constrained optimization problem based on a Lagrange function having a Lagrange multiplier, and includes selecting a computationally stable formulation or a computationally efficient formulation for solving the optimization problem.

6. The method of claim 1, wherein the reconciliation process includes splitting the nodes into a plurality of sets of nodes, and performing reconciliation separately for each set of nodes.

7. The method of claim 5, wherein the computationally stable formulation includes solving the optimization problem by solving for a vector of forecasts of the non-fixed nodes concatenated with the Lagrange multiplier.

8. The method of claim 5, wherein the computationally efficient formulation includes solving the optimization problem by solving for the Lagrange multiplier, and subsequently solving for a vector of forecasts of the non-fixed node forecasts.

9. An apparatus for generating forecasts from time series data, comprising one or more computer processors that comprise:
a processing unit including a processor configured to receive a set of time series data organized according to a data structure having a plurality of nodes, the processor configured to:
generate a plurality of base forecasts, including a base forecast for each node;
select a sub-set of the plurality of nodes as fixed nodes;
perform a reconciliation process to generate reconciled forecasts, wherein the reconciliation process includes reconciling only the base forecasts of non-fixed nodes; and
merge the base forecasts of the fixed nodes and the reconciled forecasts of the non-fixed nodes to generate an overall forecast.

10. The apparatus of claim 9, wherein the time series data is organized as at least one of a hierarchical time series and a grouped time series.

11. The apparatus of claim 9, wherein the processor is configured to select the sub-set by performing at least one of:
randomly selecting nodes from the nodes of the data structure, excluding bottom layer nodes and leaf nodes;
selecting nodes based on knowledge relating to stability of a domain of each node; and
selecting nodes based on a statistical analysis of time series data in each node.

12. The apparatus of claim 11, wherein selecting nodes based on the statistical analysis includes selecting the nodes based on a statistical stability of each node.

13. The apparatus of claim 9, wherein the reconciliation process is based on a constrained optimization problem based on a Lagrange function having a Lagrange multiplier, and includes selecting a computationally stable formulation or a computationally efficient formulation for solving the optimization problem.

14. The apparatus of claim 9, wherein the reconciliation process includes splitting the nodes into a plurality of sets of nodes, and performing reconciliation separately for each set of nodes.

15. The apparatus of claim 13, wherein the computationally stable formulation includes solving the optimization problem by solving for a vector of forecasts of the non-fixed nodes concatenated with the Lagrange multiplier.

16. The apparatus of claim 13, wherein the computationally efficient formulation includes solving the optimization problem by solving for the Lagrange multiplier, and subsequently solving for a vector of forecasts of the non-fixed node forecasts.

17. A computer program product comprising a storage medium readable by one or more processing circuits, the storage medium storing instructions executable by the one or more processing circuits to perform a method comprising:
receiving a set of time series data organized according to a data structure having a plurality of nodes;
generating a plurality of base forecasts, including a base forecast for each node;
selecting a sub-set of the plurality of nodes as fixed nodes;
performing a reconciliation process to generate reconciled forecasts, wherein the reconciliation process includes reconciling only the base forecasts of non-fixed nodes;
merging the base forecasts of the fixed nodes and the reconciled forecasts of the non-fixed nodes to generate an overall forecast.

18. The computer program product of claim 17, wherein selecting the sub-set includes at least one of:
randomly selecting nodes from the nodes of the data structure, excluding bottom layer nodes and leaf nodes;
selecting nodes based on knowledge relating to stability of a domain of each node; and
selecting nodes based on a statistical analysis of time series data in each node.

19. The computer program product of claim 17, wherein the reconciliation process is based on a constrained optimization problem based on a Lagrange function having a Lagrange multiplier, and includes selecting a computationally stable formulation or a computationally efficient formulation for solving the optimization problem.

20. The computer program product of claim 19, wherein the computationally stable formulation includes solving the optimization problem by solving for a vector of forecasts of the non-fixed nodes concatenated with the Lagrange multiplier, and the computationally efficient formulation includes solving the optimization problem by solving for the Lagrange multiplier, and subsequently solving for a vector of forecasts of the non-fixed node forecasts.
